(19) United States
(12) Patent Application Publication
(10) Pub. No.: US 2008/0075929 A1
(43) Pub. Date: Mar. 27, 2008

(54) Machineable ceramic sintered body and probe guide component

(75) Inventors: Shogo Shimada, Fukuoka (JP); Takayuki Ide, Fukuoka (JP); Masafumi Isogai, Fukuoka (JP)

Correspondence Address: CARRIER BLACKMAN AND ASSOCIATES, 24101 NOVI ROAD, SUITE 100, NOVI, MI, 48375, US

(73) Assignee: TOTO LTD., Kita-kyusyu-shi (JP)

(21) Appl. No.: 11/879,489

(22) Filed: Jul. 17, 2007

(30) Foreign Application Priority Data
Jul. 18, 2006 (JP) 2006-195695

(51) Int. Cl. C04B 35/16; B32B 3/20

(52) U.S. Cl. 428/188; 501/154

(57) ABSTRACT

The object of the present invention is to provide free-machining machineable ceramic which is excellent in free-machining property and various physical property values and which is sintered at a temperature of 1550° C. or less without a liquid phase. It is produced by sintering at a temperature of 1450-1550° C. at a composition ratio of 10-75 vol % of ZrSiO₄, 15-50 vol % of h-BN, and 10-50 vol % of ZrO₂. More preferably 10-60 vol % of ZrSiO₄, 20-50 vol % of h-BN, and 21-50 vol % of ZrO₂.

### BACKGROUND OF THE INVENTION

1. Field of the Invention

The present invention relates to a machineable ceramic sintered body which is excellent in free-machining property and various physical property values such as flexural strength, Young's modulus, coefficient of thermal expansion, and a probe guide component using this machineable ceramic sintered body.

2. Description of Prior Art

There is known machineable ceramic as a material for component parts for precision machines or semiconductor manufacturing and inspection devices. As the prior art of such machineable ceramic, there are known ones as disclosed in patent references 1-3.

In patent reference 1, there is disclosed a manufacturing method of machineable ceramic comprising the steps of wet-blending ZrO₂ with BN, Si₃N₄ and sintering assistant (Al₂O₃, Y₂O₃, etc.), drying the same, and sintering the dried powder at a temperature of 1600° C. in a nitrogen atmosphere for two hours at 30 MPa by hot pressing.

In patent reference 2, there is disclosed a manufacturing method of machineable ceramic comprising the steps of wet-blending BN with Si₃N₄ and sintering assistant (Al₂O₃, Y₂O₃, etc.), drying the same, and sintering the dried powder at a temperature of 1850° C. in a nitrogen atmosphere for two hours at 30 MPa by hot pressing.

In patent reference 3, there is disclosed a manufacturing method of machineable ceramic comprising the steps of wet-blending BN with AlN and sintering assistant such as metal or a metallic compound, drying the same, and sintering the dried powder at a temperature of 2000° C. in a nitrogen atmosphere for three hours at 20 MPa by hot pressing.

Patent reference 1: Japanese patent application publication No. 2005-119941

Patent reference 2: Japanese patent application publication No. 2001-354480

Patent reference 3: Japanese patent application publication No. S60-195059

In patent reference 1 and patent reference 2, no sufficient mechanical physical properties can be obtained since both BN and Si₃N₄ have a sintering retardant property, the formation of liquid phase (1800° C.) is necessary for obtaining a dense-sintered body. Also, in patent reference 3, no sufficient mechanical physical properties can be obtained since both BN and AlN have a sintering retardant property and the formation of liquid phase is necessary for obtaining a dense-sintered body. Moreover, due to poor machineability it is unsuitable for fine machining of high precision.

In particular, with respect to material physical properties of the component parts of the precision machines, semiconductor manufacturing and inspection devices, a machinable material having a higher strength and Young's modulus than a conventional one is required as the size of the material becomes larger and the machining becomes finer. However, because of a conventional material has a liquid phase and is sintered at a high temperature of over 1600° C., the grain growth is occurred, and mechanical physical property is deteriorated.

### SUMMARY OF THE INVENTION

The present invention was made based on such knowledge that machineable ceramic is excellent in free-machining property and mechanical thermal physical property when h-BN is dispersed in a matrix of the machineable ceramic, and the composition comprises ZrSiO₄, h-BN and ZrO₂.

The specific composition ratio of each ingredient is 10-75 vol % of ZrSiO₄, 15-50 vol % of h-BN and 10-50 vol % of ZrO₂, and preferably it is 10-60 vol % of ZrSiO₄, 20-50 vol % of h-BN and 21-50 vol % of ZrO₂.

Further, the machineable ceramic sintered body according to the present invention is characterized by its high relative density such as 95% or more. It has also high Young's modulus such as 100 GPa or more. Still further it has superior flexural strength such as 350 MPa or more.

The present invention includes a probe guide component using the above machineable ceramic sintered body. The probe guide component has a coefficient of thermal expansion of 5×10⁻⁶/K or less at a temperature of 25-200° C., for example.

### EFFECTS OF THE INVENTION

In accordance with the present invention, solid phase sintering which is not accompanied with liquid phase proceeds by selecting ZrSiO₄, h-BN and ZrO₂ as a starting material. Thereby the sintering temperature is allowed to be 1550° C. or less so that machineable ceramic which is excellent in machineability and mechanical physical property can be produced. Also, since the sintering temperature can be controlled to be low, the cost and environmental load can be reduced.

### BRIEF DESCRIPTION OF THE DRAWINGS

FIG. 1 is a view explaining the structure of a probe card member according to the present invention; and

FIG. 2 is an electron microscope (SEM) image after drilling a material according to the present invention.

### DETAILED DESCRIPTION OF PREFERRED EMBODIMENTS

First, the definition of the physical property of the machineable ceramic sintered body according to the present invention, a measuring method and a manufacturing method will be explained in detail.

Preferably, ZrO₂ is partially-stabilized or stabilized in which 3 mol % or more of Y₂O₃ is doped. If ZrO₂ contains less than 3 mol % of Y₂O₃, a crack will be caused due to contraction or expansion by the inversion of crystalline form. The evaluation method of the composition ratio can be determined by X-ray diffraction, a fluorescence X-ray, or the like.

The evaluation of free-machining property is performed by fixing a machining sample on a micro dynamometer (manufactured by Kistler Instrument Corp.), mounting a hard metal spiral drill of φ200 μm on a commercially-available machining center, and measuring machining resistance value in the axial direction of the drill.

Next, an explanation will be made in detail with regard to various physical values.

The relative density is obtained by dividing a bulk density by a theoretical density calculated based on a volume fraction.

The bulk density is measured by Archimedes' method.

The Young's modulus is measured by a resonance method based on an average value in a measured number of 3.

The flexural strength is measured by a three-point bending test based on an average value in a measured number of 5-10.

The coefficient of thermal expansion is measured at a temperature from room temperature to 200° C. with a dilatometer of a differential type based on an average value in a measured number of 2.

The Vickers hardness is measured under a load of 2.5 kg with a Vickers hardness tester based on an average value in a measured number of 10.

The meaning of the above physical properties will be explained in detail.

When the relative density is 95% or more, it is possible to improve the physical properties such as flexural strength, Young's modulus or the like, and it is also possible to prevent chipping at the time of machining, so that a product excellent in machining accuracy can be obtained.

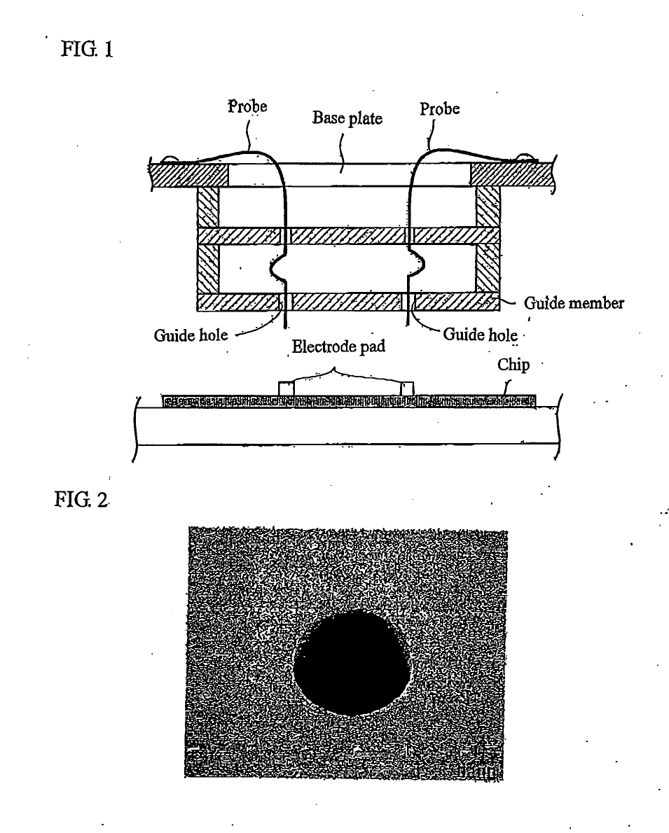

Firstly, a probe card member will be explained with reference to FIG. 1. The probe card member comprises a base plate and a guide member mounted on the base plate. On the base plate there is formed a conductor pattern. Proximal ends of probes are fixedly secured to the base plate so as to be electrically connected to the conductor pattern. On the guide member there are formed guide holes corresponding to the locations of electrode pads of a chip to be inspected. Distal ends of the probes are slidably inserted into the guide holes. The guide member is manufactured by machining guide holes or guide grooves on the free-machining machineable ceramic.

With respect to the probe card member, as the size getting larger and the higher integration progress, the higher Young's modulus is required. The Young's modulus of lower than 100 GPa might affect position accuracy error due to flexure by stress exerted on the probe card member. High integration of the probe card member makes the space between the holes decreased and the thickness of the probe card member thinned. Consequently, the high strength of 350 MPa or more is required.

As the probe card member becomes larger and highly-integrated, and a high temperature test becomes widespread, situations where the positional error of the probes due to the thermal expansion of the probe card member can not be ignored occur. Therefore, the coefficient of thermal expansion close to silicon (3.9×10⁻⁶) is required. In the high temperature test, a silicon wafer is in contact with a heater and the probe card is placed on the silicon wafer, so that the temperature of the probe card member is a little lower than that of the silicon wafer. Therefore, it is preferable that the coefficient of thermal expansion is 3.9-5.0×10⁻⁶/K.

Hereunder, the manufacturing method of the machineable ceramic sintered body of the present invention will be explained in detail. The machineable ceramic sintered body of the present invention is produced by performing wet-blending and drying to ZrSiO₄, h-BN and ZrO₂, and then sintering the same by hot pressing. Incidentally, in terms of the sintering property, it is preferable that the raw material powder of ZrSiO₄, h-BN and ZrO₂ has an average particle diameter of less than 1 μm, respectively.

The raw material is wet-blended with a ball mill or the like and granulated with a spray dryer or the like. This is packed in a graphite die and sintered by hot pressing. The atmosphere is an N₂ atmosphere. The hot pressing is carried out at a temperature of 1400-1600° C. When the temperature is too low, the sintering is not enough, so as not to develop the excellent physical property. When the temperature is too high, there is a possibility that ZrSiO₄ will be decomposed. Pressure is applied within a range of 10-50 MPa. With respect to the retention time at the maximum temperature of the hot pressing, 1-4 hours are suitable although it depends on the size.

This sintered body is excellent in free-machining property, and also has high strength and high Young's modulus. Also, the coefficient of thermal expansion is close to silicon. Accordingly, in the case where it is applied to a probe guide member of a probe card used for a semiconductor inspection apparatus, the displacement with a device to be inspected is controlled to a limited extent so as not to affect inspection even if the temperature changes. Also, the guide member becomes larger as the probe card becomes larger, which requires the high strength and high Young's modulus. The above-mentioned material can meet such requirements.

The above-mentioned material is applied to a member for guiding a probe of a probe card which is used mainly for performing a continuity test to IC and LSI. The member is comprised of a machineable ceramic sintered body on which a plurality of holes are formed by drilling. And it is used for a machining ceramic member in which the diameter of the holes is 110 μm or less, the wall thickness between the holes is 150 μm is less, and the hole diameter accuracy is within ±4 μm.

The machineable ceramic sintered body according to the present invention has high Young's modulus and high flexural strength, and the thermal expansion is as low as the coefficient of thermal expansion of silicon at a temperature from room temperature to 200° C. Therefore, it is suitable for the probe card member which is highly-integrated such that the space between the holes is decreased and the wall thickness is thinned, and whose size is increased because of a demand for batch inspection.

### EMBODIMENT

The embodiment of the present invention will be explained hereunder.

The raw material powder comprising ZrSiO₄, h-BN and ZrO₂ was wet-blended, thereafter dried, and sintered by firing with hot pressing or in a nitrogen atmosphere, or hot isostatic pressing (HIP), so as to obtain a ceramic sintered body.

As the raw material, three kinds of ZrSiO₄, h-BN and ZrO₂ were used. The average primary particle diameters are 0.9 μm, 0.1-1 μm and 0.35 μm, respectively. ZrSiO₄ contributes to improvement of Young's modulus. Cleavage of h-BN achieves an excellent free-machining property. ZrO₂ serves to make the strength high but the coefficient of thermal expansion thereof is high. By changing the composition of these materials appropriately and adjusting so as to make the thermal expansion close to that of silicon, it is possible to develop the excellent physical property as a probe guide component.

Further, by finely granulating the raw material powder, it is possible to carry out sintering at a lower temperature.

The above-mentioned raw materials were mixed to be 10-75 vol %, 15-50 vol % and 10-50 vol %, respectively, and wet-blended for two hours by a pot mill. As a solvent there was used an organic solvent such as ethanol or the like or ion exchange water. In the case where the ion exchange water is used as the solvent, a wetting agent and a dispersing agent are added since h-BN is hard to be wet. The wet-blended one was dried so as to obtain the raw material powder.

It is more preferable that the blending ratio of the material is 10-60 vol % of ZrSiO₄, 20-50 vol % of h-BN, and 21-50 vol % of ZrO₂.

After a graphite die was filled with this material powder, sintering was carried out at a temperature of 1450-1550° C. for an hour by hot pressing while applying pressure of 40 MPa thereto in a nitrogen atmosphere, so that a ceramic sintered body of 50 mm×50 mm having a thickness of 10 mm was produced.

A test specimen was cut out of this ceramic sintered body so as to measure the bulk density by Archimedes method, the Young's modulus by a resonance method, and the breaking strength by a three point bending test. Also, the coefficient of thermal expansion of the sintered body was measured at a temperature from room temperature (25° C.) to 200° C. Further, in order to evaluate machineability, drilling was conducted at a feeding speed of 6.6 μm/rev with a diamond-coated drill having a diameter of 0.2 μm. In this instance, a micro dynamometer was placed under the specimen to be drilled so as to measure a machining resistance value (in the axial direction of the drill) every five holes. The machining resistance value (average) was compared with fluorine phlogopite precipitation glass ceramic which is excellent in free-machining property. The machining resistance value is an index showing easiness of machining. As its value becomes lower, the material is more easily machined. After that, the periphery of the hole was observed by an electron microscope so as to conduct evaluation based on the degree of cracks and chipping around the hole. The evaluation results are shown by “good” in a case where there is almost no chipping, “fair” in a case where there is chipping of 20 μm-40 μm, “poor” in a case where there is chipping of more than 40 μm.

It is apparent from Table 1 that high strength and excellent machineability were developed at a temperature of 1550° C. or less so as to achieve significant improvement in comparison with conventional products. Further, FIG. 2 is an electron microscope (SEM) image after drilling the material of the present invention. It is apparent from this figure that there is no crack around the hole of the probe card member obtained by machining the machineable ceramic sintered body of the present invention.

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | | | Example | Example | Example | Example | Example | Example | Example | Example | Example |
| | | | 1 | 2 | 3 | 4 | 1 | 2 | 3 | 4 | 5 |
| Compo- | BN | [vol %] | 40 | 40 | 30 | 15 | 50 | 15 | Glass/ | AlN/BN | ZrO₂/BN/ |
| sition | ZrO₂ | [vol %] | 30 | 25 | 25 | 20 | 50 | 0 | Mica | base | Si₃N₄ |
| | ZrSiO₄ | [vol %] | 30 | 35 | 45 | 65 | 0 | 85 | base | | base |
| Physical | Bulk | g/cm³ | 4.00 | 3.92 | 4.10 | 4.51 | 4.06 | 4.22 | 2.60 | 2.90 | — |
| proper- | density | | | | | | | | | | |
| ties | Relative | % | 97.3 | 97.2 | 97.0 | 99.2 | 97.2 | 97.3 | — | — | — |
| | density | | | | | | | | | | |
| | Flexural | MPa | 508 | 440 | 466 | 465 | 254 | 341 | 181 | 300 | 320 |
| | strength | | | | | | | | | | |
| | Young's | GPa | 145 | 151 | 162 | 216 | 130 | — | 61 | 190 | 145 |
| | modulus | | | | | | | | | | |
| | Vickers | GPa | 3.8 | 3.7 | 4.6 | 7.9 | — | — | 2.1 | 3.9 | 1.3 |
| | hardness | | | | | | | | | | |
| | Coefficient | ×10⁻⁶/K | 4.89 | 3.8 | 3.63 | 3.83 | 8.29 | 3.04 | 9.4 | 4.4 | 4.5 |
| | of thermal | | | | | | | | | | |
| | expansion | | | | | | | | | | |

| | | | | | | | | | |
|---|---|---|---|---|---|---|---|---|---|
| Machining resistance value [N] | 5.7 | 5.2 | 9.6 | 21 | 2.6 | — | 8 | 13 | — |
| Periphery of hole | good | good | good | fair | good | poor | good | good | — |

### INDUSTRIAL APPLICABILITY

The machineable ceramic according to the present invention can be used, for example, as a probe card or the like for inspecting the continuity of semiconductor devices such as IC or LSI.

1. A machineable ceramic sintered body comprising ZrSiO₄, h-BN and ZrO₂.

2. The machineable ceramic sintered body according to claim 1, wherein a composition ratio of ingredients of the ceramic sintered body is ZrSiO₄: 10-75 vol %, h-BN: 15-50 vol %, and ZrO₂: 10-50 vol %.

3. The machineable ceramic sintered body according to claim 1, wherein a composition ratio of ingredients of the ceramic sintered body is 10-60 vol % of ZrSiO₄, 20-50 vol % of h-BN, and 21-50 vol % of ZrO₂.

4. The machineable ceramic sintered body according to claim 1, having a relative density of 95% or more.

5. The machineable ceramic sintered body according to claim 1, having a Young's modulus of 100 GPa or more.

6. The machineable ceramic sintered body according to claim 1, having a flexural strength of 350 MPa or more.

7. The machineable ceramic sintered body according to claim 1, wherein the body is a probe guide component having a plurality of through holes formed therein, which are adapted for passage of probes therethrough.

8. The machineable sintered ceramic body according to claim 7, having a coefficient of thermal expansion of 5×10⁻⁶/K or less at a temperature of 25-200° C.

9. The machineable ceramic sintered body according to claim 2, having a relative density of 95% or more.

10. The machineable ceramic sintered body according to claim 2, having a Young's modulus of 100 GPa or more.

11. The machineable ceramic sintered body according to claim 2, having a flexural strength of 350 MPa or more.

12. The machineable ceramic sintered body according to claim 2, wherein the body is a probe guide component having a plurality of through holes formed therein, which are adapted for passage of probes therethrough.

13. The machineable sintered ceramic body according to claim 12, having a coefficient of thermal expansion of 5×10⁻⁶/K or less at a temperature of 25-200° C.

14. The machineable ceramic sintered body according to claim 3, having a relative density of 95% or more.

15. The machineable ceramic sintered body according to claim 3, having a Young's modulus of 100 GPa or more.

16. The machineable ceramic sintered body according to claim 3, having a flexural strength of 350 MPa or more.

17. The machineable ceramic sintered body according to claim 3, wherein the body is a probe guide component having a plurality of through holes formed therein, which are adapted for passage of probes therethrough.

18. The machineable sintered ceramic body according to claim 17, having a coefficient of thermal expansion of 5×10⁻⁶/K or less at a temperature of 25-200° C.

19. A method of manufacturing a machineable ceramic sintered body comprising the steps of:
forming a mixture of ZrSiO₄, h-BN and ZrO₂; and
sintering the machineable ceramic sintered body at a temperature of 1550 degrees Celsius or less without formation of a liquid phase.

20. The method of manufacturing a machineable sintered ceramic body according to claim 19, wherein the mixture is formed to have a composition ratio of 10-75 vol % ZrSiO₄, 15-50 vol % of h-BN, and 10-50 vol % of ZrO₂; and said sintering step is performed at a temperature of between 1450 degrees Celsius and 1550 degrees Celsius.
